(19) United States
(12) Patent Application Publication
(10) Pub. No.: US 2013/0251157 A1
(43) Pub. Date: Sep. 26, 2013

(54) SYSTEM FOR REPRODUCING AN AUDIO SIGNAL

(71) Applicant: HARMAN BECKER AUTOMOTIVE SYSTEMS GMBH, Karlsbad (DE)

(72) Inventors: Tobias Münch, Straubenhardt (DE); Philipp Schmauderer, Hofen (DE); Christoph Benz, Ohlsbach (DE); Andreas Körner, Waldronn (DE)

(73) Assignee: Harman Becker Automotive Systems GmbH, Karlsbad (DE)

(21) Appl. No.: 13/849,408

(22) Filed: Mar. 22, 2013

(30) Foreign Application Priority Data
Mar. 22, 2012 (EP) EP12002030.0-1247

(51) Int. Cl. H04R 5/04

(52) U.S. Cl. CPC H04R 5/04
USPC 381/17

(57) ABSTRACT

A system for reproducing an audio signal may start a selection mode to retrieve the audio signal based on a first user input, and reproduce, in the selection mode, a first audio signal and a second audio signal. The system may filter the first audio signal and the second audio signal in the selection mode so that the first audio signal at a first location and the second audio signal at a second location are separated acoustically in a virtual acoustic space by the filtering. In the selection mode, in order to select the first audio signal the first location in the virtual acoustic space may be positioned acoustically closer to a listening position of a user than the second location of the second audio signal. The selection mode may end, if a time out of a time counter is detected.

### BACKGROUND OF THE INVENTION

1. Priority Claim

This application claims the benefit of priority from European Patent Application No. EP12002030.0-1247, filed Mar. 22, 2012, which is incorporated by reference.

2. Technical Field

The present invention relates to a method for retrieving and a system for reproducing an audio signal.

3. Related Art.

Convolution can be used in acoustics such as in a sound recording studio. The increasing computing power of special DSPs (DSP—Digital Signal Processor) and the home computer also permits the use of convolution in sound studios. When one excites a room with a short (broadband) pulse, one hears an echo that is characteristic for this room and that emphasizes or damps specific frequency components of the pulse as a result of the room's geometry and dimensions, the room's basic structure, the room's interior, and other specific characteristics. If the echo is now recorded, one thus obtains the impulse response of this room. The impulse response contains the complete characteristic of the (linear) room. In the technique of convolution, this impulse response is now utilized in order to combine any other desired acoustic signals with the impulse response through the mathematical process of convolution. For example, a discrete, fast convolution (FFT—Fast Fourier Transformation) for discrete (digitized) periodic signals is used to generate the acoustic characteristic of the room. As an alternative to determining impulse responses for a specific room, the impulse response can also be obtained through modeling, such as ray tracing and a source image model.

When a room is bounded by flat surfaces, the reflected sound components can be calculated by means of the source image method by constructing mirror-image sound sources. By means of modeling, it is possible to alter the position of the sound source and thus generate a new impulse response. By means of the impulse response, a signal for reproduction is faded out using an associated filter. The spatial impression is the auditory perception that one receives from the room itself when a sound event occurs. The spatial impression augments the acoustic information that comes directly from the sound source with important information about the environment, about the size and character of the room. The spatial impression consists of multiple components: the perception of the width and depth of the room, (room size); the perception of liveliness, which prolongs each sound event and can fuse a sound event with a following sound event; and the perception of space. Digital filters are a tool used in digital signal processing. One implementation of a filter can be achieved using convolution. This type of filter is called an FIR filter (Finite Impulse Response). Small rooms can be simulated based on an approximate image expansion, such as for rectangular non-rigid wall enclosures.

### SUMMARY

An audio signal reproduction system can retrieve an audio signal. The system may include a selection mode for retrieving the audio signal. The selection mode may be started based on a first user input. In the selection mode, a first audio signal can be reproduced. In addition, in the selection mode, a second audio signal can be reproduced substantially simultaneously with the first audio signal. In the selection mode, the first audio signal and the second audio signal can be filtered. The first audio signal may be at a first location and the second audio signal may be at a second location when separated acoustically in a virtual acoustic space by the filtering. In selection mode, in order to select the first audio signal, the first location in the virtual acoustic space can be positioned acoustically closer to a listening position of the user than the second location of the second audio signal.

In the audio signal reproduction system, the first audio signal can be automatically selected and the selection mode can end if a timing out of a time counter is detected. In order to end the selection mode, the first audio signal can be reproduced and the second audio signal can be faded out. The selection of the audio signal can occur conveniently. A selection of the audio signal can also be made solely acoustically. For example an occupant in a vehicle need not look at a display to make a selection, and may instead use audible sound a hands free command, such as voice commands to make a selection.

The system for reproducing an audio signal can be connected to electroacoustic transducers, such as loudspeakers or headphones. The system for reproducing an audio signal can be configured to start a selection mode for retrieving an audio signal. The starting of the selection mode can be based on a first user input. The system may be configured to reproduce a first audio signal in the selection mode. The system may be configured to reproduce a second audio signal substantially simultaneously with the first audio signal in the selection mode. The system may be configured to filter the first audio signal and the second audio signal in the selection mode by means of a filter. The first audio signal may be at a first location and the second audio signal may be at a second location. The first location and the second location can be separated acoustically in a virtual acoustic space based on the filtering. Here the filtering can position the first audio signal at a different three dimensional location in the virtual acoustic space than the second audio signal, such as by using convolution techniques. The filter may be realized by a digital signal processor.

The system for reproducing an audio signal can be configured to position the first location in the virtual acoustic space acoustically closer to a listening position of a listener/user than the second location of the second audio signal in order to select the first audio signal. The system can be configured to position the first location in the selection mode. The system for reproducing an audio signal can be configured to end the selection mode, if a timing out of a time counter is detected. The system can be configured to reproduce the first audio signal and to fade out the second audio signal in order to end the selection mode.

In an example, in the selection mode, a second user input may be detected before the timing out of the time counter. The first audio signal may be selected and the selection mode may end, if the second user input for selecting the first audio signal is detected. Therefore the system for reproducing an audio signal may operate to end the selection mode, if the second user input for selecting the first audio signal is detected.

The first audio signal and the second audio signal may be digital signals, which have a number of channels, for example, two stereo channels. A reproduction mode for the reproduction of audio signals can be provided before the selection mode and after the selection mode. In the reproduction mode, in contrast to the selection mode, a single audio signal, for example, a stereo signal of a radio receiver may be reproduced at a given time. In addition, other modes, for example, for outputting navigation instructions, telephone, or other audible sound can be provided. Additionally, in other examples, at least a third audio signal and/or a fourth audio signal may be reproduced during selection mode. The user can hear the first, second, third and fourth audio signals concurrently, but acoustically separated. In some examples, two or more audio signals are reproduced during selection mode.

In another example, the first audio signal and the second audio signal can be reproduced substantially simultaneously, but separated in a virtual acoustic space. This example operation can also be called spatialization. In this case, there are several possibilities for separation of the first audio signal and the second audio signal. For example, the first audio signal can be reproduced exclusively by at least one first loudspeaker, whereas substantially simultaneously the second audio signal can be reproduced exclusively by at least one second loudspeaker. In this case, the distance of the arrangement of the first loudspeaker and of the second loudspeaker can provide the distance between the first location of the first audio signal and the second location of the second audio signal in the virtual acoustic space. In other examples, additional audio signals and loudspeakers may be used.

In another example, more than two audio signals can be output over at least two loudspeakers arranged at a distance from one another. The audio signals can be reproduced by both loudspeakers at different volume such that an audio image perceived by a listener can be closer to one loudspeaker or the other loudspeaker, such as further left or further right in the virtual acoustic space. In addition, an audio signal can be reproduced such that an audio image is perceived as being in the middle between the loudspeakers, such as when both loudspeakers are at the same volume. Separation in the virtual acoustic space of the perceived audio image to be in several intermediate positions between far left and far right is also called panning

In another example, the first audio signal and the second audio signal can be arranged in different spatial depths of the virtual acoustic space. For this purpose, convolution is used in that each audio signal is filtered with different filter coefficients. For example, an FIR filter (Finite Impulse Response Filter), sometimes also called a transversal filter, can be used for the convolution. The location of the audio signal can be positioned as desired in the virtual acoustic space by means of the filter parameters, where the filter parameters may be developed by the convolution. A number of first filter coefficients can be loaded in a first filter block of a filter for filtering for the first location and a number of second filter coefficients can be loaded in a second filter block of a filter for the second location. In this case, the location in the virtual acoustic space is the perceived source position at which the listener locates the corresponding audio signal acoustically.

To end the selection mode, if the timing out of a time counter is not detected, the user need not wait for the time counter to lapse, but can end the selection mode at any time using a second user input for selecting the first audio signal. However, the timing out of the time counter provides an automatic ending of the selection mode, so that the selection mode may be manually concluded by a user, or automatically concluded based on the time counter. For example, in certain conditions in a vehicle, such as a traffic situation, a driver has the choice of making or not making the second user input. There also could be other events, such as acoustic events, interrupting or terminating the selection mode, like receipt of a phone call or issuance of navigation instructions.

In an example, in the selection mode, the first location of the first audio signal in the virtual acoustic space and/or the second location of the second audio signal in the virtual acoustic space can be changed based on a third user input. The first audio signal and/or the second audio signal at a location in the virtual acoustic space can be perceived as being positioned closer to a listening position of the user or farther from the listening position of the user by using the third user input. Advantageously, audio signals, positioned acoustically closer to the listening position, can be defined for a selection. In the selection mode, preferably for selection of the first audio signal, the first location in the virtual acoustic space can have a perceived position closer to a listening position of the user than the second location of the second audio signal.

In the selection mode, the second and/or third user input may occur via touching of a touch screen or actuation of a button or actuation of a selector wheel or any other form of user input for adjusting a perceived position.

In an example, the selection mode the first audio signal and the second audio signal can be reproduced at a different volume in the virtual acoustic space. Advantageously, in the selection mode for the selection of the first audio signal a first volume of the first audio signal can be controlled to be higher than a second volume of the second audio signal in the virtual acoustic space. In this case, the first audio signal in the virtual acoustic space is perceived to be closer to a listening position of the user than the second audio signal.

According to an example, the first audio signal is associated with a first audio source and the second audio signal is associated with a second audio source. For example, the first audio signal originates from a first radio receiver and the second audio signal originates from a second radio receiver. With the first radio receiver a first radio station is received, whereas with the second receiver a second radio station is received. In selection mode, the user can hear both radio stations concurrently but acoustically separated. With the second input the user may decide which radio station is selected for continuous playback, and exit the selection mode.

According to an example, the first audio signal can be associated with a first database entry and the second audio signal can be associated with a second database entry. The first audio signal in this case is advantageously generated from a first audio file and the second audio signal in this case is advantageously generated from a second audio file.

In an example, a first visual information item, associated with the first audio signal, can be displayed. Moreover, a second visual information item, associated with the second audio signal, can be displayed. One of the first or second visual information item can be, for example, a text and/or a picture and/or a video. The other of the first or second visual information item can be, for example, a cover or title or a station name or the like. An acoustic arrangement of the first location of the first audio signal and the second location of the second audio signal can correspond to a visual arrangement of the first visual information item and the second visual information item on a display. The display can be any mechanism or device for providing visual images, such as, for example, a screen or a projector.

There can be several options for arranging the first visual information item with respect to the second visual information item. For example, if the first visual information item is arranged in a position in front of the second visual information item, such as if the first visual information item partially conceals from view the second visual information item, then the first location of the first audio signal can also be arranged in a similar corresponding perceived acoustic position in front of a perceived acoustic position of the second location of the second audio signal in the virtual acoustic space. For example, if the first visual information item is arranged to the left of the second visual information item, then the first location of the first audio signal can also be arranged to the left of the second location of the second audio signal in the virtual acoustic space. For example, if the first visual information item is arranged above the second visual information item, then the first location of the first audio signal can also be arranged above the second location of the second audio signal in the virtual acoustic space.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The invention may be better understood with reference to the following drawings and description. The components in the figures are not necessarily to scale, emphasis instead being placed upon illustrating the principles of the invention.

FIG. 1 is a block diagram example of the audio signal reproduction system, loudspeakers, and a virtual acoustic space that also shows an example display for radio reception.

FIGS. 2a and 2b is another block diagram example of the audio signal reproduction system, loudspeakers, and a virtual acoustic space that also shows an example display of selection from a database.

FIGS. 3a and 3b is yet another block diagram example of the audio signal reproduction system, loudspeakers, and a virtual acoustic space that also shows an example display for selecting an individual title.

FIG. 4 is an operational flow diagram illustrating an example operation of the audio signal reproduction system.

### DETAILED DESCRIPTION

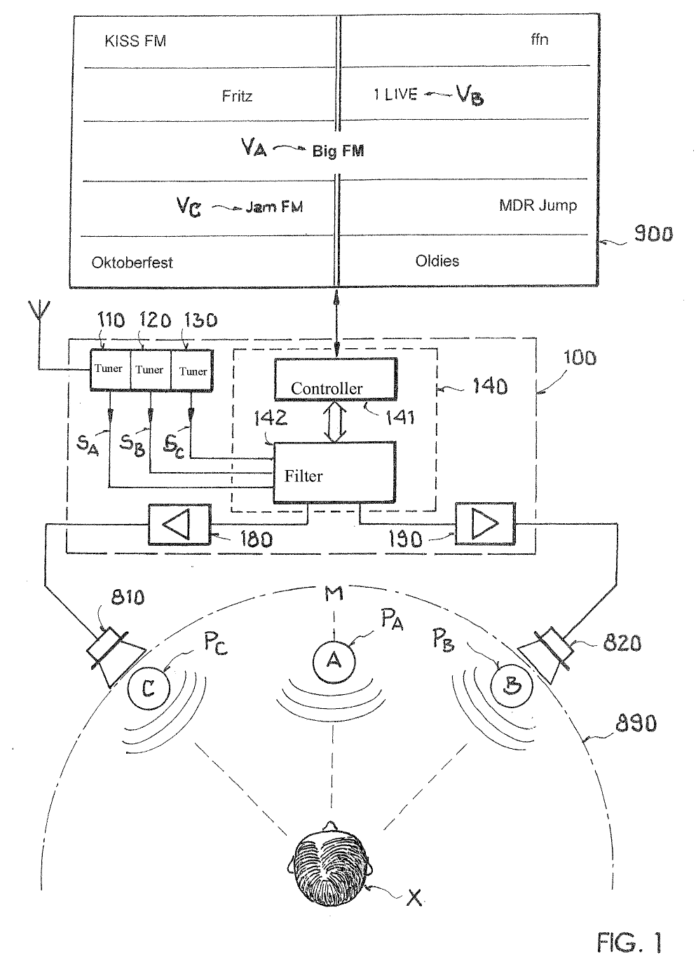

In FIG. 1, an example of an infotainment system of, for example, a motor vehicle. The infotainment system includes a system for reproducing an audio signal 100. The system for reproducing an audio signal 100 can include any number of tuners, such as three tuners 110, 120, 130, which output as audio sources a first digital audio signal S_{A}, a second digital audio signal S_{B}, and a third digital audio signal S_{C}. The system 100 can include an arithmetic unit 140 with a controller 141 and a digital filter 142. The term “unit” is defined to include one or more executable modules, at least some of which may be embodied in a computer readable storage medium as executable instructions. Accordingly, as described herein, units are defined to be hardware executable by the processor, such as a computer readable storage medium that may include instructions executable by the processor, a field programmable gate array (FPGA), and/or various devices, components, circuits, gates, circuit boards, and the like that are executable, directed, and/or controlled for performance by a processor.

The controller 141 may include a processor. The processor may be one or more general processors, digital signal processors, application specific integrated circuits, field programmable gate arrays, digital circuits, analog circuits, combinations thereof, and/or other now known or later developed devices for analyzing and processing data.

The arithmetic unit 140 may also include memory. The memory may include a main memory, a static memory, and/or a dynamic memory. The memory may include, but is not limited to computer readable storage media, or machine readable media, such as various types of non-transitory volatile and non-volatile storage media, including but not limited to random access memory, read-only memory, programmable read-only memory, electrically programmable read-only memory, electrically erasable read-only memory, flash memory, magnetic tape or disk, optical media and the like. In one example, the memory includes a cache or random access memory for the processor. In addition or alternatively, the memory may be separate from the processor, such as a separate cache memory of a processor, the system memory, or other memory. The memory may also include (or be) an external storage device or database for storing data. Examples include a hard drive, compact disc (“CD”), digital video disc (“DVD”), memory card, memory stick, floppy disc, universal serial bus (“USB”) memory device, or any other device operative to store data. The memory is operable to store data and instructions executable by the processor. The functions, acts or tasks illustrated in the figures or described may be performed by or in connection with the programmed processor executing the instructions stored in the memory. The functions, acts or tasks may be independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The filter 142 is configured, for example, as a DSP (Digital Signal Processor). Further, the system 100 can include, or be coupled with a first output circuit 180, which can be connected to a first loudspeaker 810. Further, the system 100 can include, or be coupled with a second output circuit 190, which can be connected to a second loudspeaker 820. Output circuit 180, 190 may include, for example, a digital-to-analog converter and an amplifier for amplifying and outputting an analog signal to loudspeaker 810, 820. In other examples, any number of output circuits and loudspeakers may be included.

If the loudspeakers are arranged at a distance to one another, a surround sound is generated by the system 100 by means of spatialization. The surround sound can be generated, for example, by outputting the third audio signal S_{C} exclusively by first loudspeaker 810 and the second audio signal S_{B} exclusively by second loudspeaker 820. In this case, the third audio signal S_{C} for user X at a listening position is heard exclusively from the direction “far left,” whereas the second audio signal S_{B} for user X is heard exclusively from the direction “far right.” The first audio signal S_{A} may be output through both loudspeakers 810, 820 at the same volume and therefore is perceived as being heard by user X from the middle M between the two loudspeakers 810, 820. The middle M in this case designates a first location P_{A} in a virtual acoustic space 890, “right” designates a second location P_{B} in acoustic space 890, and “left” designates a third location P_{C} in acoustic space 890. In addition, the user X designates a listening position in the virtual acoustic space. In other examples, any other locations and listening positions may be used.

The substantially simultaneous reproduction of the first audio signal S_{A}, the second audio signal S_{B}, and the third audio signal S_{C}, as shown in FIG. 1, are provided for a selection mode in which user X would like to retrieve one of the audio signals S_{A}, S_{B}, S_{C}. The tuners 110, 130 and 130 providing the first audio signal S_{A}, the second audio signal S_{B}, and the third audio signal S_{C}, may receive and provide respective audio content, such as audio content transmitted from different radio stations.

In the example of FIG. 1, different radio stations identified as “Jam FM,” “Big FM,” or “1LIVE,” may be providing audio content as the first audio signal S_{A}, the second audio signal S_{B}, and the third audio signal S_{C}. In an example, if user X does not know the transmitted program of the radio stations “Jam FM,” “Big FM,” or “1LIVE,” then the user can navigate through the substantially simultaneous, but spatially separated hearing of several radio stations. The navigation through the receivable radio stations can occur, for example, by receipt of a user input, such as by an input by means of a selection wheel. In the selection mode, the navigation through the radio stations can occur acoustically, so that user X, while driving the vehicle through dense traffic, need not look away from the street while acoustically sampling the different radio stations, and can concentrate completely on the traffic.

For the system to enter the selection mode, a user input received from user X may direct the system to leave, for example, a reproduction mode in which a radio station is reproduced as a stereo signal. Receipt of the input can be the result of, for example, the actuation of a button, touching of the touch screen, performing a gesture command, or by a voice command recognized by speech recognition, e.g., “search function.” With the start of the selection mode, the stereo reproduction of the reproduction mode is deactivated.

In the example of FIG. 1, three tuners 110, 120, 130 are provided, each of which outputs one digital audio signal S_{A}, S_{B}, S_{C}. This digital audio signal S_{A}, S_{B}, S_{C} can be output, for example, as a mono signal or stereo signal or multichannel signal. In the selection mode, it can be advantageous to change the first audio signal S_{A} and respectively the second and third audio signal S_{B}, S_{C} in each case to a mono signal, for example, by filtering only one channel of the particular stereo signal through filter 142. In a virtual acoustic space 890, the first audio signal S_{A} is separated acoustically by the filtering by filter 142 so as to be acoustically perceived by a user at the listening position as being positioned at a first location P_{A}. In addition, the second audio signal S_{B} can be acoustically perceived by the user as being positioned at a second location P_{B}, and the third audio signal S_{C} acoustically perceived by the user as being at a third location P_{C}. In the example of FIG. 1 the locations are indicated as “middle”-“right”-“left,” respectively.

The selection mode of the system shown in FIG. 1 can be ended by user X when the user X selects the first audio signal S_{A} by a further user input. The user input is, for example, detected as a signal input based on a button actuation, touching of a touch screen, gesture command, or voice command input. At the end of the selection mode, the reproduction mode (not shown) of the system can be started by reproducing the selected first audio signal S_{A} as a multi-channel signal and fading out the second audio signal S_{B} and the third audio signal S_{C} such that the selected first audio signal S_{A} is played in the loudspeakers 810 and 820.

In addition to the acoustic retrieval of the audio signal S_{A}, in the example of FIG. 1, an optional visualization is shown by displaying an animated radio station list on a display 900. The display 900 may be any form of visual display device, such as a liquid crystal display (LCD), an organic light emitting diode (OLED), a flat panel display, a solid state display, a cathode ray tube (CRT), a projector, or other now known or later developed display device for outputting determined information. The display 900 may act as an interface for the user to see the functioning of the controller 141, or specifically as an interface with the software stored in the memory. The system may also include an input device configured to allow a user to interact with any of the components of system. The input device may be a keypad, a keyboard, or a cursor control device, such as a mouse, or a joystick, touch screen display, remote control or any other device operative to interact with the system.

The radio station list is generated by controller 141. In the example of FIG. 1, a first text string V_{A} “Big FM” associated with the first audio signal S_{A} is shown as the first visual information item V_{A}, a second text string V_{B} “1LIVE” associated with the second audio signal S_{B} as the second visual information item V_{B}, and a third text string V_{C} “Jam FM” associated with the third audio signal S_{C} as the third visual information item V_{C}.

The visual arrangement of the first visual information item V_{A}, the second visual information item V_{B}, and the third visual information item V_{C} can correspond to an acoustic arrangement of the first location P_{A} of the first audio signal S_{A}, the second location P_{B} of the second audio signal S_{B}, and the third location P_{C} of the third audio signal S_{C} in the virtual acoustic space 890. Thus, in the FIG. 1, the third location P_{C} is arranged to the left of first location P_{A} and the second location P_{B} to the right of first location P_{A} in the virtual acoustic space 890 and, accordingly, the third visual information item V_{C} is arranged to the left of the first visual information item V_{A} and the second visual information item V_{B} to the right of the first visual information item V_{A} on display 900.

In addition, filter 142 can be configured to influence additional audio properties of the first audio signal S_{A}, the second audio signal S_{B}, and the third audio signal S_{C}. For example, the frequency response of the audio signals S_{A}, S_{B}, S_{C} can be changed by the filtering. In addition, filter 142 can be configured to selectively boost or cut the frequency ranges in the first audio signal S_{A} and/or in the second audio signal S_{B} and/or in the third audio signal S_{C}. For example, in FIG. 1, a frequency response of the first audio signal S_{A}, which is available directly for selection, is not changed by the filter 141. In contrast, a frequency bandwidth of the second audio signal S_{B} and of the third audio signal S_{C} is changed by significantly attenuating, for example, the bass and/or treble of the second audio signal S_{B} and of the third audio signal S_{C} due to a high-pass filter or bandpass filter being included in the filter 141.

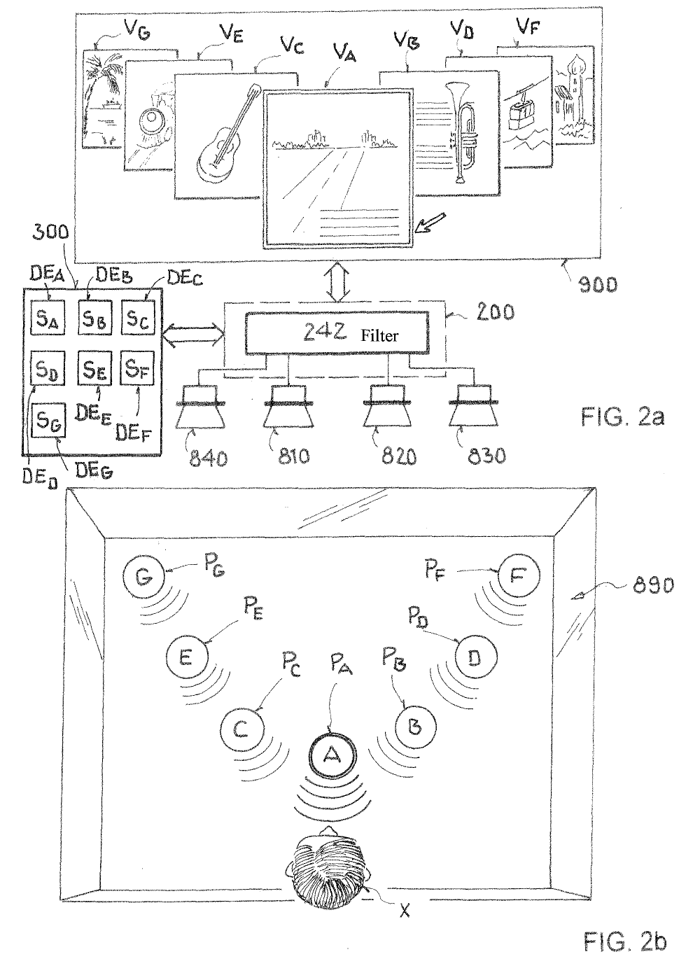

Another example of an infotainment system is shown schematically in FIGS. 2a and 2b. In this example, visual image rendering applications, such as Album art applications make it possible to look at visual information items or visual images, such as music covers V_{A}, V_{B}, V_{C}, V_{D}, V_{E}, V_{F}, V_{G} and to page through these visual information items to select corresponding audio content. The visual information items and/or the audio content may be stored in a location, such as a database included in, or accessible by, the infotainment system. If a user knows this database very well and can recognize and match the visual information items or images, such as covers V_{A}, V_{B}, V_{C}, V_{D}, V_{E}, V_{F}, V_{G} with associated music capable of being output by the infotainment system, this could be sufficient for a user to select and retrieve desired music from the database. If, on the other hand, a user is unable to select audio content based on corresponding visual images, for example a user who does not know the covers corresponding to music content, it could be more helpful to preview the audio content acoustically as well, and to make a selection of audio content based on the audible sounds instead of only the visual images, such as graphic information V_{A}, V_{B}, V_{C}, V_{D}, V_{E}, V_{F}, V_{G}. The audio sounds may include, for example, audio titles of the audio content. In FIG. 1, the audio signal S_{A} associated with the current cover image V_{A} is acoustically perceived at the listening position as being played frontally before user X by a method of the virtual acoustics, and, in this case, the audio signals S_{B}, S_{C} of adjacent cover images V_{B}, V_{C} are acoustically perceived or heard as being spatially farther away/closer and can thereby be moved three dimensionally into the depth of the virtual acoustic space 890. As a result, a more pleasant acoustic mixture of the audio signal S_{A}, S_{B}, S_{C} can be achieved and more than three audio signals can be played simultaneously. In addition, the system allows a user the capability to browse or page through audio content and corresponding visual information items, while at the same time having the acoustically perceived location of the audio content move three dimensionally to be closer or farther away from the listening location, as the corresponding visual information items move three dimensionally closer or farther away on the display.

A system for reproducing an audio signal 200 included in the infotainment system in the example of FIG. 2a includes a filter 242, which can be used in connection with four loudspeakers 810, 820, 830, 840 of, for example, a motor vehicle. The system 200 can include a controller, and be in communication with a memory 300 via an interface, for example, a USB interface or a SATA interface. For purposes of brevity, discussion of similar features and functionality described with regard to the system for reproducing audio signals 100 of FIG. 1 will be minimized. Entries DE_{A} to DE_{G} of a database are stored in memory 300. Each entry DE_{A}, DE_{B}, DE_{C}, DE_{D}, DE_{E}, DE_{F}, DE_{G} includes a file with an audio signal S_{A}, S_{B}, S_{C}, S_{D}, S_{E}, S_{F}, S_{G}. In addition, a visual information item V_{A}, V_{B}, V_{C}, V_{D}, V_{E}, V_{F}, V_{G}, associated with each audio signal S_{A}, S_{B}, S_{C}, S_{D}, S_{E}, S_{F}, S_{G}, can be stored. In one example, the audio signal S_{A}, S_{B}, S_{C}, S_{D}, S_{E}, S_{F}, S_{G} may be audio content in the form of music, and the visual information item may be in the form of a cover image V_{A}, V_{B}, V_{C}, V_{D}, V_{E}, V_{F}, V_{G}, which are all shown on display 900 in the example of FIG. 2a. In this case, the illustration in FIG. 2a is greatly simplified since a much greater number of entries can be present in the database. For example, in the case of music audio content, a plurality of titles with one audio file each is stored for an album of a cover V_{A}, V_{B}, V_{C}, V_{D}, V_{E}, V_{F}, V_{G}.

In the example of FIGS. 2a and 2b, a selection mode for retrieving one of the audio signals S_{A}, S_{B}, S_{C}, S_{D}, S_{E}, S_{F}, S_{G} is started based on a first user input of user X that is received as an input signal by the system for reproducing an audio signal 200. For example, user X can operate an associated button (not shown) on display 900 configured as a touch screen. In the selection mode, audio signals S_{A}, S_{B}, S_{C}, S_{D}, S_{E}, S_{F}, S_{G}, associated with the visual information items, such as cover images V_{A}, V_{B}, V_{C}, V_{D}, V_{E}, V_{F}, V_{G}, can be reproduced substantially simultaneously. Moreover, the visual information items, such as cover images V_{A}, V_{B}, V_{C}, V_{D}, V_{E}, V_{F}, V_{G} can be displayed substantially simultaneously on touch screen 900.

The audio signals S_{A}, S_{B}, S_{C}, S_{D}, S_{E}, S_{F}, S_{G} can be filtered in the selection mode by filter 242 in such a way that, as shown schematically in FIG. 2b, the audio signals S_{A}, S_{B}, S_{C}, S_{D}, S_{E}, S_{F}, S_{G} are separated acoustically to be perceived as being at different locations P_{A}, P_{B}, P_{C}, P_{D}, P_{E}, P_{F}, P_{G} in a virtual acoustic space 890. A plan view of the virtual acoustic space 890 is shown schematically in FIG. 2b. Filter 242 may include a number of filter blocks. Each of the filter blocks can filter an audio signal S_{A}, S_{B}, S_{C}, S_{D}, S_{E}, S_{F}, S_{G}. Alternatively, the filter 242 may be a number of different separate filters having filter blocks filtering corresponding audio signal S_{A}, S_{B}, ^{S}_{C}, S_{D}, S_{E}, S_{F}, S_{G}. A filter coefficient set, which is associated with a respective one of the locations P_{A}, P_{B}, P_{C}, P_{D}, P_{E}, P_{F}, P_{G} in the virtual acoustic space 890, can be selectively loaded in each filter block in accordance with the operation of the system. For example, in the selection mode, filter coefficients may be loaded in the filter blocks to create acoustically perceived audio outputs at the different locations, whereas in a continuous playback mode or reproduction mode, filter coefficients may be loaded in the filter blocks to output audio content of a multi-channel audio signal to the loudspeakers to create, for example, a stereo or surround sound listening experience at the listening position. The output signals of the filter blocks can be added, such as by superposition, to form output signals to drive each loudspeaker 810, 820, 830, 840. In other examples, each filter block may drive a separate loudspeaker.

The acoustically perceived location P_{A}, P_{B}, P_{C}, P_{D}, P_{E}, P_{F}, P_{G} of the respective audio signal S_{A}, S_{B}, ^{S}_{C}, S_{D}, S_{E}, S_{F}, S_{G} in virtual acoustic space 890 corresponds thereby to the position of the associated visual information items, such as cover image V_{A}, V_{B}, V_{C}, V_{D}, V_{E}, V_{F}, V_{G} on touch screen 900. The arrangement of the acoustically perceived locations P_{A}, P_{B}, P_{C}, P_{D}, P_{E}, P_{F}, P_{G} of the audio signals S_{A}, S_{B}, S_{C}, S_{D}, S_{E}, S_{F}, S_{G} in virtual space 890 and accordingly the arrangement of the visual information items, such as cover images V_{A}, V_{B}, V_{C}, V_{D}, V_{E}, V_{F}, V_{G} on touch screen 900 can be changed by means of an input by user X, for example, by moving a finger across touch screen 900. For example, if the finger slides from right to left across touch screen 900, the cover V_{G} is faded out far left, a new cover is faded in on the right (not shown), and instead of the cover V_{A}, the cover V_{B} is moved to the foreground (indicated by an arrow in FIG. 2a).

The filter coefficient sets in the filter blocks are correspondingly re-loaded such that, the audio signal S_{G} is faded out, a new audio signal associated with the new cover is faded in (not shown), and instead of the audio signal S_{A}, the audio signal S_{B} is acoustically positioned three dimensionally in the foreground (indicated by an arrow) of the virtual acoustic space 890.

In addition to the three dimensional virtual placement in the virtual acoustic space 890, each of the audio signals S_{A}, S_{B}, S_{C}, S_{D}, S_{E}, S_{F}, S_{G} can be reproduced at a different volume in accordance with the desired acoustically perceived location. For example, in the situation of FIG. 2b, the first audio signal S_{A} at location P_{A} is reproduced at a higher volume than the other audio signals S_{B}, S_{C}, S_{D}, S_{E}, S_{F}, S_{G}. The selection mode is ended at a time when user X selects the cover image V_{A} on touch screen 900 or, when a time counter times out after a predetermined time of being in the selection mode, for example, a 20 second time counter times out.

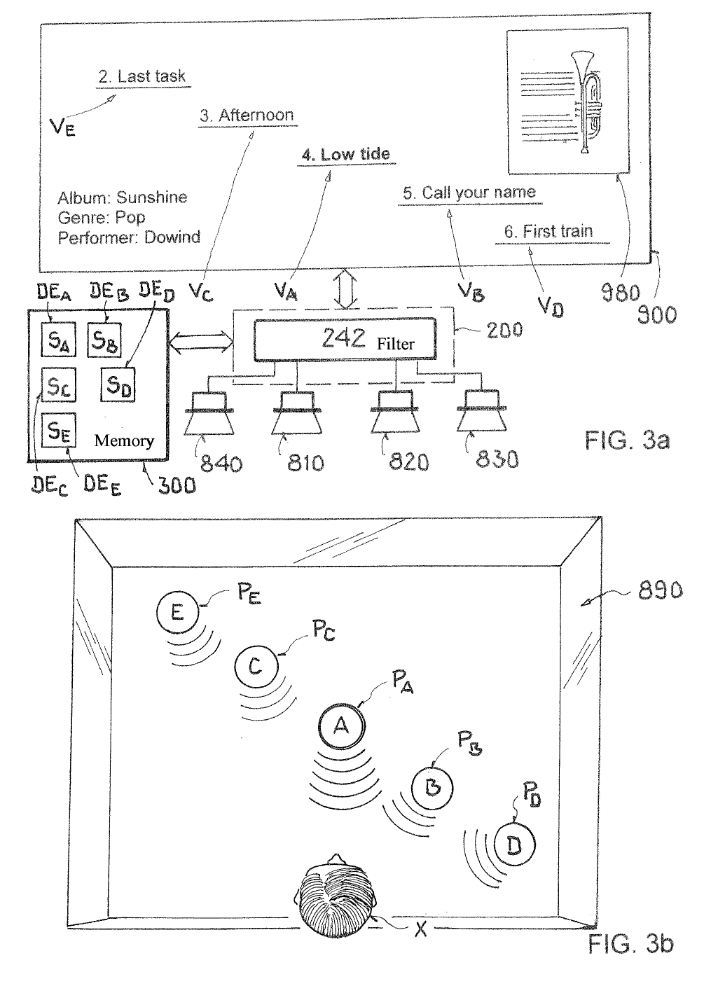

At the end of the selection mode, the display on touch screen 900 of FIG. 2a can be changed. For example, in the case of audio content that is music, and a corresponding visual information item, such as the cover image V_{A}, the cover image V_{A} can be moved to another position and the titles of the album may be listed, as is shown schematically, for example, in FIG. 3a for a cover 980. In addition, in the example of FIGS. 2a and 2b, the associated audio signal S_{A} can be reproduced in the reproduction mode as a stereo signal or multichannel signal to drive the loudspeakers, and all other audio signals S_{B}, S_{C}, S_{D}, S_{E}, S_{E}, S_{G} can be faded out.

A further example of an infotainment system is shown schematically in FIGS. 3a and 3b. For purposes of brevity, discussion of similar features and functionality described with regard to the system for reproducing audio signals 100 and 200 of FIGS. 1 and 2 will be minimized. In FIG. 3, it is possible in the selection mode during paging through the visual information items, such as titles V_{A}, V_{B}, V_{C}, V_{D}, V_{E}, to begin playing the audio signal S_{A} corresponding to the title V_{A} “Low tide,” currently shown in the foreground, at a normal volume. Audio signals S_{B}, S_{C}, S_{D}, S_{E} of the other visual information items, such as titles V_{B}, V_{C}, V_{D}, V_{E} may be mixed in to the audio output of the loudspeakers more quietly so as to be acoustically perceived to be before and behind. For example, when the titles V_{A}, V_{B}, V_{C}, V_{D}, V_{E} are to be paged through from left to right, the audio signal S_{C} of the corresponding left-sided title V_{C} “Afternoon” can be reproduced exclusively on left loudspeaker 810 and the audio signal S_{B} of the right-sided title V_{B} “Call your name” can be exclusively reproduced on right loudspeaker 820. In the example of FIGS. 3a and 3b, however, the audio signals S_{A}, S_{B}, S_{C}, S_{D}, S_{E} are arranged in an acoustically perceived staggered alignment in the virtual acoustic space 890 and thereby correspond to the visually perceived staggered arrangement of the titles in FIG. 3a. It may also be possible by appropriate filtering of the frequency response to arrange the locations P_{A} to P_{E} at a different acoustically perceived height level in the acoustic space, for example, with an increasing/decreasing height level.

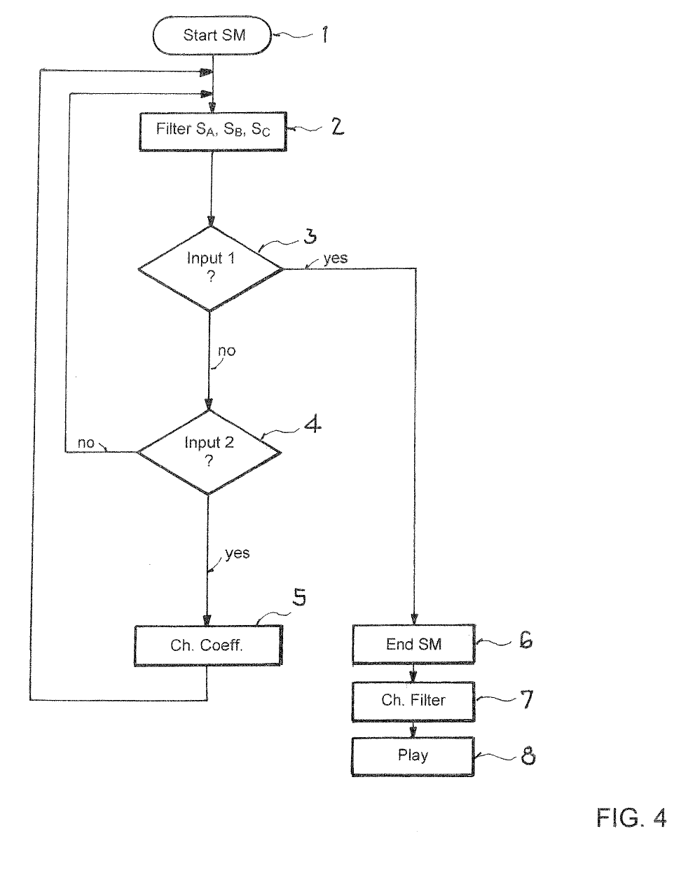

A process flow in the form of a schematic flow diagram with example operational process steps 1 to 8 of the system for reproducing audio signals is shown schematically in FIG. 4. Here, the flow diagram is simplified for easier comprehension. In a first process step 1, a selection mode SM is started and in a next second step 2, the audio signals S_{A}, S_{B}, S_{C} are filtered in such a way that the audio signals S_{A}, S_{B}, S_{C} are separated acoustically in a virtual acoustic space 890, so that they are heard, or perceived, by the user at locations P_{A}, P_{B}, P_{C} in virtual acoustic space 890 at a distance from one another.

In a third step 3, a user input “Input1” is detected. The user input in this case, for example, is made by selection of the audio signal S_{A} for continuous play, for example, by touching the associated title V_{A} on a touch screen 900. If there is a user input, the selection mode SM is ended in a sixth step 6, then the filter coefficients for reproducing the selected audio signal S_{A} are changed in the filter blocks in step 7, and the selected audio signal S_{A} is reproduced continuously in an eighth step 8.

If, in contrast, the user input “Input1” does not occur in the third step 3, in a fourth step 4 another user input “Input2” is detected. The additional user input is, for example, a moving of a visual information item, such as a cover on touch screen 900 by a sliding movement of the finger. If the further user input is detected, the filter coefficients in the filter blocks are correspondingly changed in the fifth step 5, so that in the next step 2 the specific audio signal S_{A}, S_{B}, S_{C} is heard at moved acoustically perceived locations in virtual space 890 or faded out and/or a new audio signal is faded in. If no further user input occurs in the fourth step 4, the filtering occurs unchanged with the previous filter coefficients.

The invention is not limited to the shown embodiment variants in FIGS. 1 through 4. For example, it is possible to use other signal sources, like CD-player or aux-in etc as audio sources for audio signals. It is also possible to use a different or settable number of audio signals in the virtual acoustic space. The selection mode can be used, for example, for mobile audio devices with headphones, for smartphones, for personal computers or for tablets. The functionality of the exemplary embodiments can be used especially advantageously for an infotainment system of a motor vehicle.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

### LIST OF REFERENCE CHARACTERS

| | |
|---|---|
| 100, 200 | circuit, infotainment system |
| 110, 120, 130 | audio source, receiver |
| 140 | arithmetic unit |
| 141 | controller, μC |
| 142, 242 | filter, DSP |
| 180, 190 | output circuit |
| 810, 820, 830, 840 | sound transducer, loudspeaker |
| 890 | virtual acoustic space |
| 900 | display, touch screen |
| A, B, C, D, E, F, G | item, assignment |
| DE_{A}, DE_{B}, DE_{C}, DE_{D}, DE_{E}, DE_{F}, | database entry |
| DE_{G} | |
| M | middle |
| P_{A}, P_{B}, P_{C}, P_{D}, P_{E}, P_{F}, P_{G} | location in the virtual acoustic space |
| S_{A}, S_{B}, S_{C}, S_{D}, S_{E}, S_{F}, S_{G} | audio signal |
| SM | selection mode |
| V_{A}, V_{B}, V_{C}, V_{D}, V_{E}, V_{F}, V_{G} | visual information, cover |
| X | user, listener |

We claim:

1. A method for retrieving an audio signal comprising the steps:
starting with a controller a selection mode for retrieving the audio signal based on a first user input;
reproducing with the controller in the selection mode a first audio signal;
reproducing with the controller in the selection mode a second audio signal substantially simultaneously with the first audio signal;
filtering the first audio signal and the second audio signal with a filter in the selection mode to acoustically produce the first audio signal at a first location and the second audio signal at a second location, the first location and the second location being separated acoustically in a virtual acoustic space based on the filtering;
in the selection mode, in response to a user selection of the first audio signal, the controller acoustically positioning the first location in the virtual acoustic space acoustically closer to a listening position than an acoustic position of the second location of the second audio signal;
the controller ending the selection mode in response to detection of a timing out of a time counter; and
reproducing the first audio signal and fading out the second audio signal with the controller to end the selection mode.

2. The method according to claim 1, further comprising, in the selection mode, based on a third user input, the controller changing the acoustic position of at least one of the first location of the first audio signal in the virtual acoustic space or the second location of the second audio signal in the virtual acoustic space.

3. The method according to claim 1, further comprising the controller ending the selection mode if a second user input for selecting the first audio signal is detected.

4. The method according to claim 1, further comprising, in the selection mode, the controller reproducing the first audio signal and the second audio signal at a different volume level in the virtual acoustic space.

5. The method according to claim 1, where the first audio signal is associated with a first audio source, and the second audio signal is associated with a second audio source.

6. The method according to claim 1, where the first audio signal is associated with a first database entry, and the second audio signal is associated with a second database entry.

7. The method according to claim 1, further comprising:
displaying on a display a first visual information, associated with the first audio signal,
displaying a second visual information associated with the second audio signal on the display, and
acoustically arranging the first location of the first audio signal and the second location of the second audio signal with the controller to correspond to a visual arrangement of the first visual information and the second visual information, respectively.

8. A system for reproducing an audio signal connectable to electroacoustic transducers, comprising:
a controller configured to start a selection mode for retrieving an audio signal based on a first user input;
the controller configured to reproduce a first audio signal in the selection mode;
the controller configured to reproduce a second audio signal substantially simultaneously with the first audio signal in the selection mode;
a filter configured to filter the first audio signal and the second audio signal in the selection mode, where the filtered first audio signal is at a first location and the filtered second audio signal is at a second location, the first location and the second location being separated acoustically in a virtual acoustic space by the filtering;
the controller further configured to position the first location in the virtual acoustic space acoustically closer to a listening position than the second location of the second audio signal in the selection mode, in order to select the first audio signal;
the controller further configured to end the selection mode, in response to detection of a timing out of a time counter; and
the controller further configured to reproduce the first audio signal, and to fade out the second audio signal to end the selection mode.

9. The system of claim 8, where the controller is further configured, in response to a user input, to change the filter coefficients of the filter so that the filtered first audio signal is moved from the first location to a third location, and the filtered second audio signal is moved from a second location to a fourth location, the third location and the fourth location being separated acoustically in a virtual acoustic space by the filtering.

10. The system of claim 8, where the first location and the second location are acoustically perceived locations of a respective sound image at a listening location in the virtual acoustic space.

11. The system of claim 8, where the controller is further configured to produce the first audio signal and the second audio signal at different volume levels.

12. The system of claim 8, where the filter is configured to leave unchanged the bandwidth of the first audio signal, and to change the bandwidth of the second filter in accordance with the first location being positioned in the virtual acoustic space acoustically closer to the listening position.

13. The system of claim 8, where the first audio signal and second audio signals are three dimensionally acoustically positioned in the virtual acoustic space so that the first location is positioned in the virtual acoustic space acoustically closer to the listening position than the second location of the second audio signal.

14. The system of claim 13, where the first audio signal and the second audio signal are three dimensionally acoustically positioned at different heights in the virtually acoustic space.

15. A method of reproducing an audio signal used to drive electroacoustic transducers, the method comprising:
receiving a first audio signal and a second audio signal with a controller;
entering a selection mode with the controller;
filtering the first audio signal with a first filter to acoustically produce the first filtered audio signal at a first location in a virtual acoustic space in response to entry into the selection mode;
filtering the second audio signal with a second filter to acoustically produce the second filtered audio signal at a second location in the virtual acoustic space in response to entry into the selection mode, the first location being acoustically closer to a listening position in the virtual acoustic space than the second location;
receiving a first input signal indicative of a user input;
changing filter coefficients of the first filter and the second filter, in response to receipt of the first user input to acoustically produce the first audio signal at a third location in the virtual acoustic space and to acoustically produce the second audio signal at a fourth location in the virtual acoustic space, the fourth location being acoustically closer to the listening position than the third location;
receiving a second input signal indicative a time out of a timer;
exiting the selection mode with the controller in response to receipt of the second input signal; and
changing the filter coefficients of the first filter and the second filter with the controller in response to the second input signal, and filtering the second audio signal with both the first filter and the second filter to produce a multi-channel output signal in the virtual acoustic space.

16. The method of claim 15, further comprising the controller positioning a first visual image and a second visual image in a display, the first visual image being associated with the first audio signal, and the second visual image being associated with the second audio signal, and visually representing the first visual image as being closer to the listening position than the second visual image when the first audio signal is acoustically located closer to the listening position.

17. The method of claim 15, further comprising maintaining a frequency bandwidth of the first audio signal as unchanged with the first filter, and adjusting the frequency bandwidth of the second audio signal with the second filter when the first audio signal is acoustically located closer to the listening position.

18. The method of claim 17, further comprising changing the frequency bandwidth of the first audio signal with the first filter, and maintaining the frequency bandwidth of the second audio signal as unchanged with the second filter when the second audio signal is acoustically located closer to the listening position.

19. The method of claim 15, further comprising the controller positioning a first visual image and a second visual image in a display, the first visual image being associated with the first audio signal, and the second visual image being associated with the second audio signal, and changing an acoustically perceived height of the first and second locations in the virtual acoustic space with the controller in accordance with a change in height of the first visual image and the second visual image in the display.

20. The method of claim 15, further comprising receiving a third input signal indicative of a user input prior to receipt of the second input signal, the third input signal indicative of a user selection of the first audio signal and filtering the first audio signal with both the first filter and the second filter to produce a multi-channel output signal in the virtual acoustic space.
